(19) United States
(12) Patent Application Publication
(10) Pub. No.: US 2026/0234991 A1
(43) Pub. Date: Aug. 13, 2026

(54) ROMAN SHADE

(71) Applicant: LEAFY WINDOWARE CO., LTD., Dongguan City, Guangdong Province (CN)

(72) Inventors: Zhenbang LEI, Dongguan City, Guangdong Province (CN); Xingbang LEI, Dongguan City, Guangdong Province (CN)

(21) Appl. No.: 18/718,791

(22) PCT Filed: Jan. 24, 2022
(86) PCT No.: PCT/CN2022/073462

§ 371 Date: May 1, 2026

(51) Int. Cl. E06B 9/322; E06B 9/262

(52) U.S. Cl. CPC E06B 9/322; E06B 9/262; E06B 2009/2625; E06B 2009/3222

(57) ABSTRACT

A Roman shade includes first and second cording winding and unwinding devices, a shade body with a top and a bottom, a middle beam fixed to the top, a bottom beam fixed to the bottom, a first cord with a top end fixed to the first cord winding and unwinding device and a bottom end fixed to the bottom beam after extending through the shade body, and a second cord with a bottom end fixed to the middle beam and a top end connected to the second cord winding and unwinding device. The first second cord winding and unwinding devices respectively drives the bottom beam to rise or fall through winding or unwinding the first cord so as to fold or unfold the shade body and the middle beam to rise or fall through winding or unwinding the second cord so as to unfold or fold the shade body.

### FIELD OF THE PRESENT INVENTION

The present invention relates to curtain accessories and, more particularly to a Roman shade.

### BACKGROUND OF THE PRESENT INVENTION

A current Roman shade usually includes a top beam, a cord winding and unwinding device assembled on the top beam, a shade body suspended below the top beam and provided with a plurality of positioning members along a height direction, a bottom beam fixed to a bottom end of the shade body, and a cord fixed to the cord winding and unwinding device with a top end and extending through the positioning members in turn and being fixed to the bottom beam with a bottom end. The cord winding and unwinding device drives the bottom beam to rise or fall through winding or unwinding the cord, thereby allowing the shade body to be folded or unfolded. In use, the folding and unfolding of the shade body of the traditional Roman shade is one-way, that is, the shade body can usually only be folded from the bottom end to the top end along the positions of the positioning members, and be unfolded from the top end to the bottom end along the position of each positioning member, and thus that, the shading form for a window is single. When a user needs to cover a bottom area of the window but does not need to cover a top area of the window, or, when the user needs to cover a middle area of the window but does not need to cover the top and bottom areas of the window, the above-mentioned Roman shade cannot realize the use.

### SUMMARY OF THE INVENTION

### Technical Problem

Therefore, the technical problem to be solved by the embodiments of the present invention is to provide a Roman shade, which can realize two-way folding and unfolding of a shade body.

### Solutions to the Problem

To solve the above-mentioned technical problems, an embodiment of the present invention provides the following solutions. A Roman shade includes a top beam, a first cording winding and unwinding device mounted to the top beam, a shade body suspended below the top beam and forming a plurality of positioning members in a height direction, a middle beam fixed to a top end of the shade body, a bottom beam fixed to a bottom end of the shade body, a first cord including a top end fixed to the first cord winding and unwinding device and a bottom end extending through the plurality of positioning members in turn and then being fixed to the bottom beam, a second cord winding and unwinding device mounted to the top beam, and a second cord comprising a bottom end fixed to the middle beam and a top end connected to the second cord winding and unwinding device. The first cord winding and unwinding device drives the bottom beam to rise or fall through winding or unwinding the first cord, so as to fold or unfold the shade body. The second cord winding and unwinding device drives the middle beam to rise or fall through winding or unwinding the second cord, so as to unfold or fold the shade body.

Furthermore, the middle beam defines a through hole, and the first cord extends through the middle beam through the through hole.

Furthermore, a fixing mechanism is assembled in the through hole, for the first cord extending through and for fixing the second cord, the fixing mechanism includes a mounting tube fixed in the through hole and axially defining a mounting hole, and a positioning ring tightly plugged in an end of the mounting hole and defining a core hole in a middle, the first cord extends through the middle beam, through the mounting hole and the core hole, the bottom end of the second cord is clamped and positioned by an outer wall of the positioning ring and a wall bounding the mounting hole.

Furthermore, the positioning ring is plugged in a bottom end of the mounting hole from bottom to top, and the positioning ring is a truncated cone or a prism, which is thin at a top and thick at a bottom; the bottom end of the second cord is wound on the positioning ring, by extending through the core hole; a part of the second cord abutted against the outer wall of the positioning ring is clamped and positioned by the outer wall of the positioning ring and the wall bounding the mounting hole.

Furthermore, the mounting tube includes an inner tube axially defining a first shaft hole and forming a first limiting tab on an end, and an outer tube axially defining a second shaft hole and forming a second limiting tab on an end; the inner tube and the outer tube are plugged in the through hole, from a top end and a bottom end of the through hole, respectively; the first limiting tab and the second limiting tab are abutted against a top surface and a bottom surface of the middle beam, respectively; the inner tube is also plugged in the outer tube, and an outer wall of the inner tube forms a plurality of protruded rings, for increasing friction between the outer wall of the inner tube and an inner wall of the outer tube; the first shaft hole and the second shaft hole are communicated with each other, to form the mounting hole.

Furthermore, a bottom end of the second shaft hole is shaped into a truncated cone hole or a prism hole, which is thin at a top and thick at a bottom, for fitting with the positioning ring.

Furthermore, an inner wall bounding the core hole defines a slot, and a part of the second cord located in the core hole is snapped in the slot.

Furthermore, each of the first and second cord winding and unwinding device includes a power mechanism mounted to the top beam, a transmission rod driven to rotate by the power mechanism, a reel fitted about the transmission rod and relatively fixed in a circumferential direction with the transmission rod, a screw nut fixed to the top beam and screwed to the reel, and a cord guide member mounted to the top beam for guiding the first cord or the second cord to be wound on the reel; the top ends of the first cord and the second cord are wound on the reels of the first and second cord winding and unwinding devices, respectively.

Furthermore, the power mechanism includes a housing assembled to a middle of the transmission rod, a spring shaft and an output shaft rotatably mounted in the housing in parallel, and a scroll spring fitted about the spring shaft and fixed to the output shaft with an outer end; each transmission rod is circumferentially fixed to the output shaft of one power mechanism and coaxially extends through the spring shaft of the other power mechanism; the first and second cord winding and unwinding devices each includes two reels respectively assembled to two opposite ends of the transmission rod; the first cord, the second cord, the screw nut, and the cord guide member are set one-to-one correspondence with the reels of the first and second cord winding and unwinding devices; two cord guide members located at same ends of the transmission rods of the first and second cord winding and unwinding devices are integrally formed.

Furthermore, the Roman shade further includes a cord adjustment device mounted between the bottom end of the first cord and the middle beam, to adjust a length of the first cord, the cord adjustment device includes a sleeve fixed to the bottom beam, a cord shaft, and an adjustable locking assembly.

An axis of the sleeve is perpendicular to the shade body, and the sleeve is open at one end and close at the other end; a wall of the sleeve defines a cord groove communicating with an inner hole of the sleeve and extending along an axial direction of the sleeve, an end wall of the closed end of the sleeve defines a plurality of first positioning portions evenly distributed around an axis of the sleeve.

The cord shaft extends into the sleeve through the open end and rotatably mounted to the sleeve, the bottom end of the first cord extends through the cord groove and is wound on the cord shaft, an end of the cord shaft outside the sleeve forms a turning handle, for operating the cord shaft to rotate, an inner end surface of the cord shaft forms two second positioning portions, for cooperating with the plurality of first positioning portions to prevent the cord shaft from rotation.

The adjustable locking assembly is used to keep the second positioning portions of the cord shaft and the plurality of first positioning portions in a mated state; the adjustable locking assembly includes a screw extending through a locking hole defined in the cord shaft to be screwed in a screw hole defined in a middle of the end wall of the sleeve, and an elastic member arranged between a head of the screw and the cord shaft for being elastically abutted against the cord shaft to keep the second positioning portions and the plurality of first positioning portions in the mated state.

### Beneficial Effects of the Invention

By adopting the above technical solution, embodiments of the present invention have at least the following beneficial effects. The embodiments of the present application are based on traditional curtains, and the shade body can realize two-way folding and unfolding through adding the middle beam to the top end of the shade body, adding the second cord winding and unwinding device to the top beam, and connecting the middle beam to the second cord winding and unwinding device through the second cord. In use, not only the first cord winding and unwinding device drives the bottom beam to rise or fall through winding or unwinding the first cord, so as to fold the shade body from bottom to top or unfold the shade body from top to bottom, correspondingly, but also the second cord winding and unwinding device drives the middle beam to rise or fall through winding or unwinding the second cord, so as to unfold the shade body from top to bottom or fold the shade body from bottom to top. The first and second cord winding and unwinding devices can operate alone or in cooperation with each other. In this way, various covering effects can be achieved, in which a top area of a window can be covered and a bottom area of the window can be uncovered, the bottom area of the window can be covered and the top area of the window can be uncovered, or the bottom and top areas of the window can be uncovered and only a middle area of the window can be covered.

### BRIEF DESCRIPTION OF THE DRAWINGS

FIG. 1 is an exploded, isometric view of an embodiment of a Roman shade.

FIG. 2 is an assembled, isometric view of the Roman shade.

FIG. 3 is an isometric view of the Roman shade, showing the Roman shade in a working state.

FIG. 4 is another isometric view of the Roman shade, showing the Roman shade in another working state.

FIG. 5 is an exploded, isometric view of a fixing mechanism of the Roman shade.

FIG. 6 is an assembled, cross-sectional view of the fixing mechanism.

FIG. 7 is an enlarged view of a circled portion A of FIG. 1.

FIG. 8 is an isometric view of a power mechanism of the Roman shade.

FIG. 9 is a cross-sectional view of the power mechanism.

FIG. 10 is an exploded, isometric view of a cord adjustment device of the Roman shade.

FIG. 11 is another exploded, isometric view of the cord adjustment device.

FIG. 12 is an assembled, cross-sectional view of the cord adjustment device.

### DETAILED DESCRIPTION OF THE PRESENT INVENTION

The present application will be further described in detail below with reference to the accompanying drawings and embodiments. It should be understood that the following illustrative embodiments and illustrations are only used to explain the present invention and are not intended to limit the present invention, and that the embodiments of the present invention and the features of the embodiments can be combined with each other without conflict.

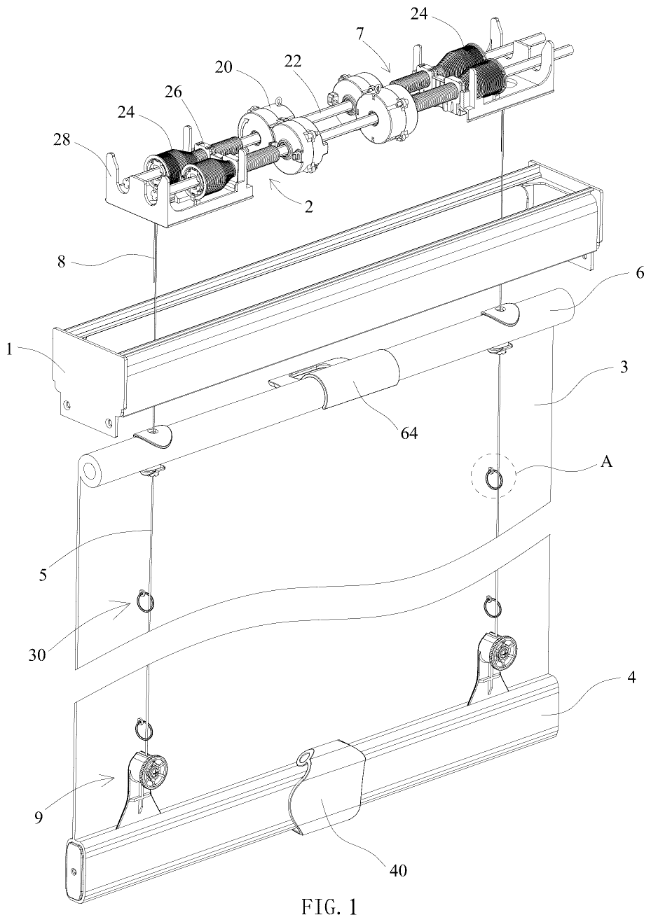

Referring to FIGS. 1-4, an embodiment of the present invention provides a Roman device including a top beam 1, a first cord winding and unwinding device 2 assembled to the top beam, a shade body 3 suspended below the top beam 1 and forming a plurality of positioning members along a height direction, a bottom beam 4 fixed to a bottom end of the shade body 3, and a first cord 5 with a top end being fixed to the first cord winding and unwinding device 2 and a bottom end extending through the positioning members 30 in turn and then being fixed to the bottom beam 4. The first cord winding and unwinding device 2 drives the bottom beam 4 to rise or fall through winding or unwinding the first cord 5, thereby folding or unfolding the shade body 3, correspondingly. The Roman shade further includes a middle beam 6 fixed to a top end of the shade body 3, a second cord winding and unwinding device 7 assembled to the top beam 1, and a second cord 8 with a bottom end being fixed to the middle beam 6 and a top end being connected to the second cord winding and unwinding device 7. The second cord winding and unwinding device 7 drives the middle beam 6 to rise or fall through winding or unwinding the second cord 7, thereby unfolding or folding the shade body 3.

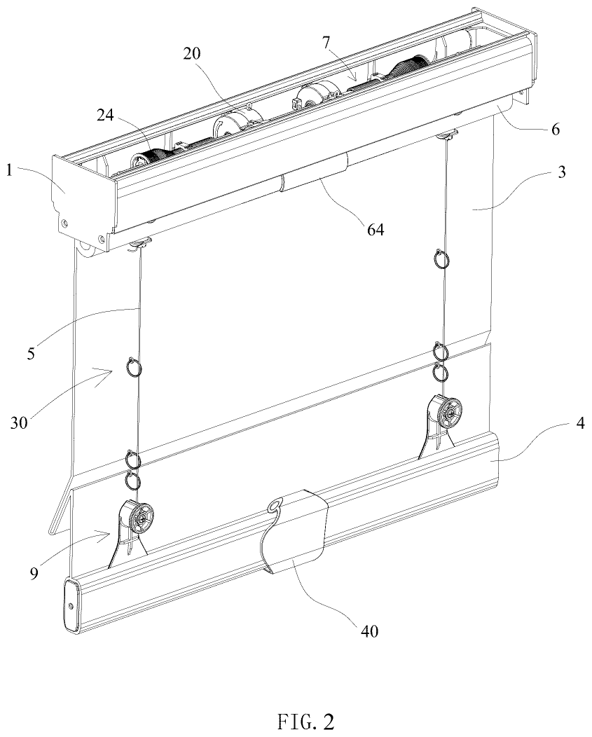

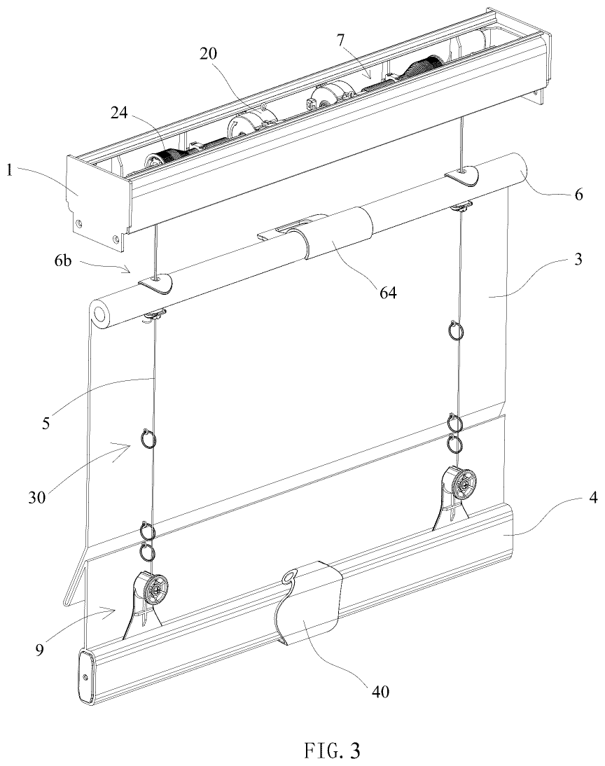

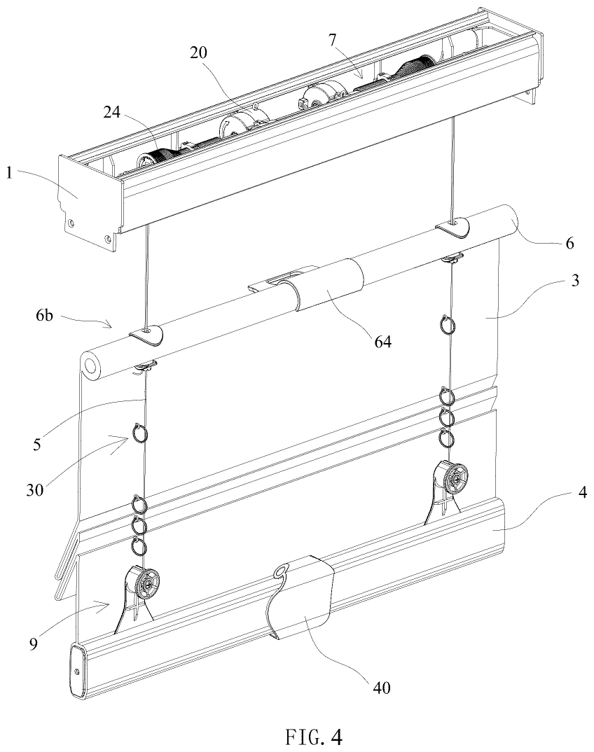

The embodiment of the present application is based on traditional curtains, and the shade body 3 can realize two-way folding and unfolding through adding the middle beam 6 to the top end of the shade body 3, adding the second cord winding and unwinding device 7 to the top beam 1, and connecting the middle beam 6 and the second cord winding and unwinding device 7 through the second cord 8. In use, not only the first cord winding and unwinding device 2 drives the bottom beam 4 to rise or fall through winding or unwinding the first cord 5, so as to fold the shade body 3 from bottom to top or unfold the shade body 3 from top to bottom, but also the second cord winding and unwinding device 7 drives the middle beam 6 to rise or fall through winding or unwinding the second cord 8, so as to unfold the shade body 3 from top to bottom or fold the shade body 3 from bottom to top. The first and second cord winding and unwinding devices 2 and 7 can operate alone or in cooperation with each other. In this way, various covering effects can be achieved, in which a top area of a window can be covered and a bottom area of the window can be uncovered (as shown in FIG. 2), the bottom area of the window can be covered and the top area of the window can be uncovered (as shown in FIG. 3), or the bottom and top areas of the window can be uncovered and only a middle area of the window can be covered (as shown in FIG. 4).

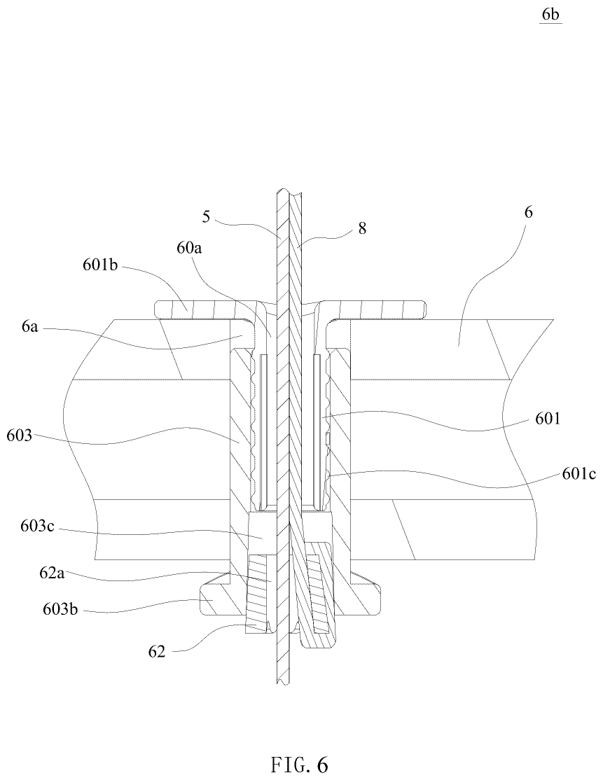

In an embodiment as shown in FIGS. 1, 5, and 6, the middle beam 6 defines a through hole 6a. The first cord 5 extends through the middle beam 6 through the through hole 6a, and the through hole 6a can achieve positioning the first cord 5, thereby avoiding the first cord 5 to swing randomly.

In an embodiment as shown in FIGS. 1, 5, and 6, a fixing mechanism 6b is assembled in the through hole 6a, for fixing the second cord 8 and for the first cord 5 extending through. The fixing mechanism 6b includes a mounting tube 60 fixed in the through hole 6a and axially defining a mounting hole 60a, and a positioning ring 62 tightly plugged in an end of the mounting hole 60a and defining a core hole 62a in a middle. The first cord 5 extends through the middle beam 6, through the mounting hole 60a and the core hole 62a. The bottom end of the second cord 8 is clamped and positioned by an outer wall of the positioning ring 62 and a wall bounding the mounting hole 60a. In the embodiment, the first cord 5 extends through the middle beam 6, through the mounting hole 60a and the core hole 62a, and the second cord 8 is clamped and positioned by the outer wall of the positioning ring 62 and the wall bounding the mounting hole 60a, which is convenient in disassembly and assembly.

In an embodiment as shown in FIGS. 1, 5, and 6, the positioning ring 62 is plugged in a bottom end of the mounting hole 60a from bottom to top. The positioning ring 62 is a truncated cone or a prism, which is thin at a top and thick at a bottom. The bottom end of the second cord 8 is wound on the positioning ring 62, by extending through the core hole 62a. A part of the second cord 8 abutted against the outer wall of the positioning ring 62 is clamped and positioned by the outer wall of the positioning ring 62 and the wall bounding the mounting hole 60a. In the embodiment, during the positioning ring 62 being plugged in the bottom end of the mounting hole 60a from bottom to top, a distance between the outer wall of the positioning ring 62 and the wall bounding the mounting hole 60a gradually reduces, so as that the second cord 8 is gradually tightened, thereby achieving stable positioning.

In an embodiment as shown in FIGS. 1, 5, and 6, the mounting tube 60 includes an inner tube 601 axially defining a first shaft hole 601a and forming a first limiting tab 601b on an end, and an outer tube 603 axially defining a second shaft hole 603a and forming a second limiting tab 603b on an end. The inner tube 601 and the outer tube 603 are plugged in the through hole 6a, from a top end and a bottom end of the through hole 6a, respectively. The first limiting tab 601b and the second limiting tab 603b are abutted against a top surface and a bottom surface of the middle beam 6, respectively. The inner tube 601 is also plugged in the outer tube 603, and an outer wall of the inner tube 601 forms a plurality of protruded rings 601c, for increasing friction between the outer wall of an inner tube 601 and an inner wall of the outer tube 603. The first shaft hole 601a and the second shaft hole 603a are communicated with each other, to form the mounting hole 60a. In the embodiment, the inner tube 601 and the outer tube 603 are connected through the protruded rings 601c on the inner tube 601, to form the mounting tube 60. The protruded rings 601c can increase the friction between the inner tube 601 and the outer tube 603, allowing the connection of the inner tube 601 and the outer tube 603 to be more stable. The first limiting tab 601b and the second limiting tab 603b are respectively abutted against the top and bottom surfaces of the middle beam 6, which can effectively position the inner and outer tubes 601 and 603 in the through hole 6a.

In an embodiment as shown in FIGS. 1, 5, and 6, a bottom end of the second shaft hole 603a is shaped into a truncated cone hole or a prism hole 603c that is thin at a top and thick at a bottom, for fitting with the positioning ring 62, which can effectively cooperate with the positioning ring 62 to clamp and fix the second cord 8, so as to prevent the second cord 8 from loosening due to excessive force.

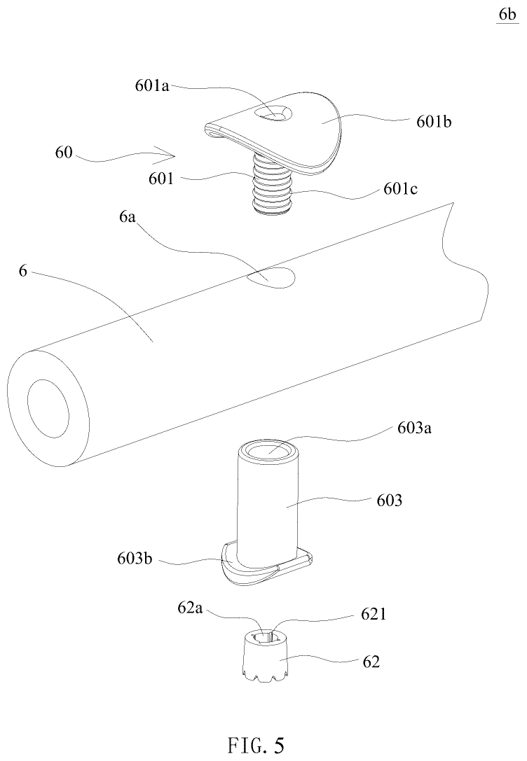

In an embodiment as shown in FIG. 5, an inner wall bounding the core hole 62a defines a slot 621. A part of the second cord 8 located in the core hole 62a is snapped in the slot 621, for further positioning the second cord 8, so as to ensure that the second cord 8 is stably fixed by the positioning ring 62.

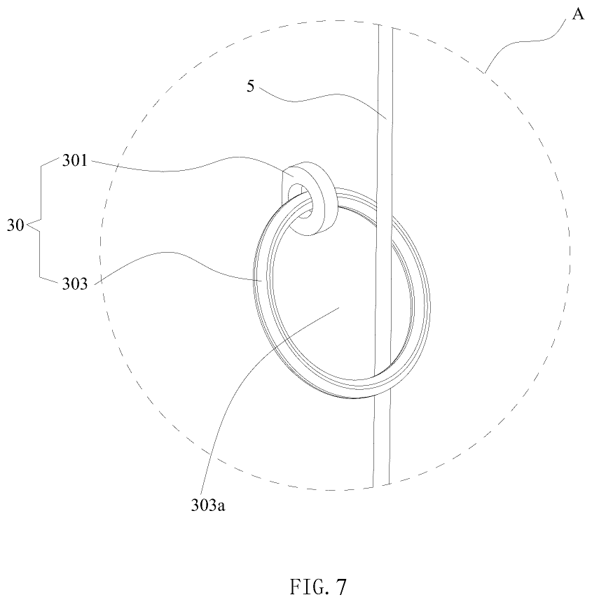

In an embodiment as shown in FIG. 7, each positioning member 30 includes a fixing ring 301 fixed to the shade body 3, and a location ring 303 movably fitted about the fixing ring 301. The first cord 5 extends through a center hole 303a defined in the location ring 303. In the embodiment, the positioning member 30 adopts the fixing ring 301 and the location ring 303, so as that, on the one hand, the folding position of the shade body 3 can be effectively limited, and on the other hand, the location ring 303 can flexibly swing to adapt to the movement of the second cord 5. Moreover, as shown in FIG. 1, a first operation member 40 is formed on the bottom beam 4, for operating the bottom beam 4, and a second operation member 64 is formed on the middle beam 6, for operating the middle beam 6, which is convenient for users to operate the bottom beam 3 and the middle beam 6, so as to realize the folding and unfolding of the shade body 3.

In an embodiment as shown in FIG. 1, structures of the first and second cord winding and unwinding devices 2 and 7 are the same, each of which includes a power mechanism 20 mounted to the top beam 1, a transmission rod 22 driven to rotate by the power mechanism 20, a reel 24 fitted about the transmission rod 22 and relatively fixed in a circumferential direction with the transmission rod 22, a screw nut 26 fixed to the top beam 1 and screwed to the reel 22, and a cord guide member 28 mounted to the top beam 1 for guiding the first cord 5 or the second cord 8 to be wound on the reel 22. The top ends of the first cord 5 and the second cord 8 are wound on the reels 24 of the first and second cord winding and unwinding devices 2 and 7, respectively. In the embodiment, the structures of the first and second cord winding and unwinding devices 2 and 7 are the same, so as that design costs are relatively lower. The first and second cords 5 and 8 are guided by the cord guide members 28 to be wound on the reels 24, respectively. In use, the power mechanism 20 drives the reel 24 to rotate relative to the screw nut 26 through the transmission rod 22. The reel 24 realizes the corresponding folding and unfolding of the shade body 3 by winding and unwinding the first cord 5 or the second cord 8.

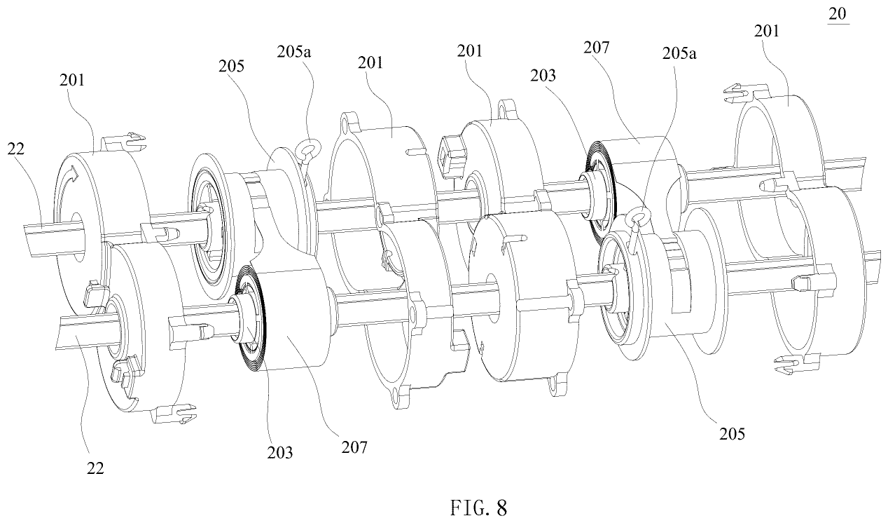

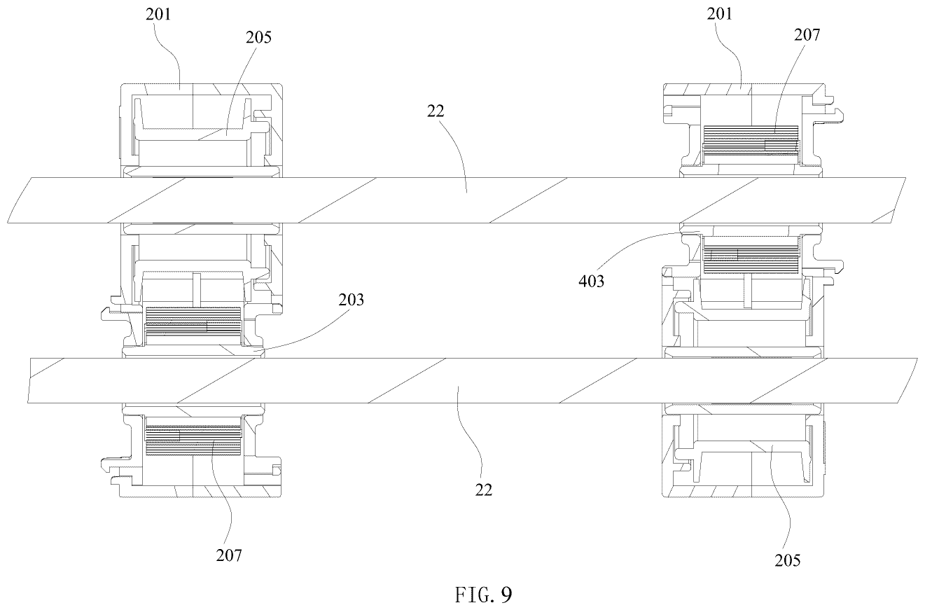

In an embodiment as shown in FIGS. 1, 8, and 9, the power mechanism 20 includes a housing 201 assembled to a middle of the transmission rod 22, a spring shaft 203 and an output shaft 205 rotatably mounted in the housing 201 in parallel, and a scroll spring 207 fitted about the spring shaft 203 and fixed to the output shaft 205 with an outer end. Each transmission rod 22 is circumferentially fixed to the output shaft 205 of one power mechanism 20 of one of the first and second cord winding and unwinding devices 2 and 7, and coaxially extends through the spring shaft 203 of the other power mechanism 20 of the other one of the first and second cord winding and unwinding devices 2 and 7. The first and second cord winding and unwinding devices 2 and 7 each includes two reels 24 respectively assembled to two opposite ends of the transmission rod 22. The first cord 5, the second cord 8, the screw nuts 26, and the cord guide members 28 are set one-to-one correspondence with the reels 24. The two cord guide members 28 located at same ends of the two transmission rods 22 of the first and second cord winding and unwinding devices 2 and 7 are integrally formed. In the embodiment, the power mechanism 20 adopts the above-mentioned structure, which is simple in structure, and can effectively drive the reels 24 to wind and unwind the first cord 5 and the second cord 8. Each transmission rod 22 is circumferentially fixed to the output shaft 205 of one power mechanism 20 and coaxially extends through the spring shaft 203 of the other power mechanism 20, which can effectively optimize space layout, ensure the mutual cooperation between various structural parts, and the opposite ends of the transmission rod 22 each is set with one reel 24, which ensures that the shade body 3 folds and unfolds smoothly. Moreover, the two cord guide members 28 located at the same ends of the two transmission rods 22 of the first and second cord winding and unwinding devices 2 and 7 are integrally formed, which has lower design cost and easier assembly. In the embodiment as shown in FIGS. 8 and 9, each transmission rod 22 coaxially extends through the output shaft 205 and the spring shaft 203 of different power mechanisms 20. Moreover, a lateral locking member 205a, such as a screw, extends through the output shaft 205 and then is locked to the transmission rod 22, to realize the relative fixation of the transmission rod 22 and the output shaft 205 in a circumferential direction.

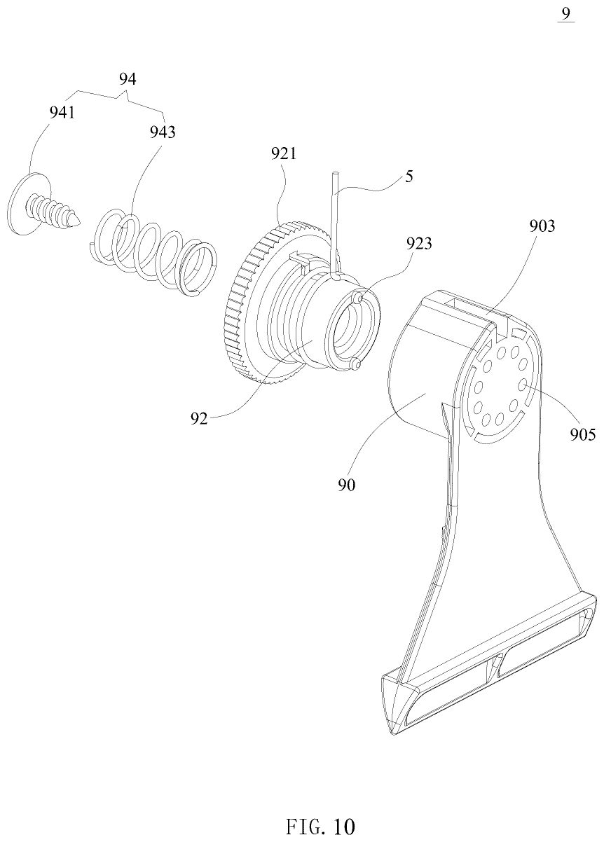

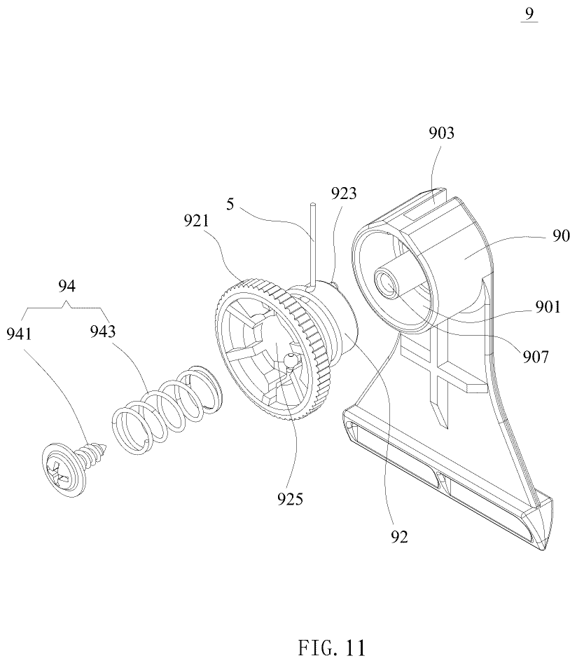

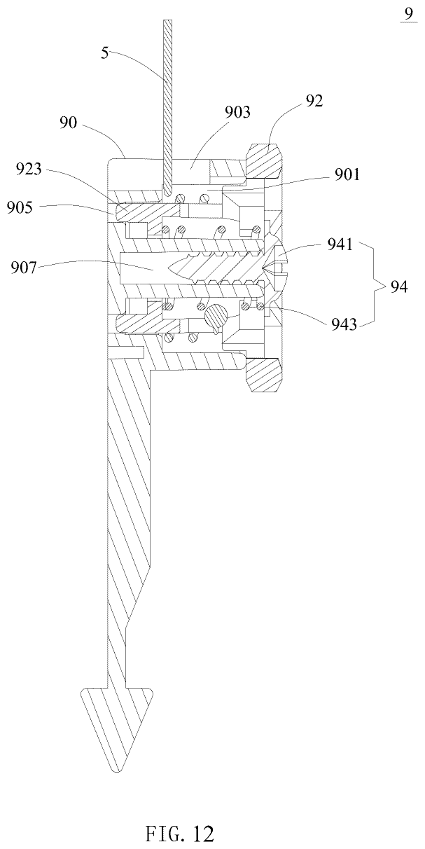

In an embodiment as shown in FIGS. 10-12, the Roman shade further includes a cord adjustment device 9 mounted between the bottom end of the first cord 5 and the middle beam 6, to adjust a length of the first cord 5. The cord adjustment device 9 includes a sleeve 90 fixed to the bottom beam 4, a cord shaft 92, and an adjustable locking assembly 94.

An axis of the sleeve 90 is perpendicular to the shade body 3, and the sleeve 90 is open at one end and close at the other end. A wall of the sleeve 90 defines a cord groove 903 communicating with an inner hole 901 of the sleeve 90 and extending along an axial direction of the sleeve 90. An end wall of the closed end of the sleeve 90 defines a plurality of first positioning portions 905 evenly distributed around a central axis of the sleeve 90.

The cord shaft 92 extends into the sleeve 90 through the open end and is rotatably mounted to the sleeve 90. The bottom end of the first cord 5 extends through the cord groove 903 and is wound on the cord shaft 92. An end of the cord shaft 92 outside the sleeve 90 forms a turning handle 921, for operating the cord shaft 92 to rotate. An inner end surface of the cord shaft 92 forms two second positioning portions 923, for cooperating with the first positioning portions 903 to prevent the cord shaft 92 from rotation.

The adjustable locking assembly 94 is used to keep the second positioning portions 923 of the cord shaft 92 and the first positioning portions 903 in a mated state. The adjustable locking assembly 94 includes a screw 941 extending through a locking hole 925 defined in the cord shaft 92 to be screwed in a screw hole 907 defined in a middle of the end wall of the sleeve 90, and an elastic member 943 arranged between a head of the screw 941 and the cord shaft 92 for being elastically abutted against the cord shaft 92 to keep the second positioning portions 923 and the first positioning portions 903 in the mated state.

In the embodiment, the cord shaft 92 extends into the inner hole 901 of the sleeve 90, the bottom end of the first cord 5 extends through the cord groove 903 defined in the wall bounding the inner hole 901 and is wound on the cord shaft 92, the cord shaft 92 forms the second positioning portions 923 cooperating with the first positioning portions 905 of the sleeve 90 to prevent the cord shaft 92 from rotating, and the adjustable locking assembly 94 limits an axial displacement of the cord shaft 92. When the length of the first cord 5 needs to be adjusted, the screw 941 of the locking assembly 94 is loosened an appropriate distance away from the sleeve 90, and the turning handle 921 is operated to pull the cord shaft 92 outwards to allow the second positioning portions 923 of the cord shaft 92 to disengage from the first positioning portions 905. The cord shaft 92 then can be rotated to wind a predetermined length of the first cord 5. After a part of the first cord 5 outside the cord adjustment device 9 reaches a desired length, the second positioning portions 921 of the cord shaft 92 are engaged into the first positioning portions 905 of the sleeve 90 again. The screw 941 of the locking assembly 94 is finally tightened. Since the elasticity of the elastic member 943 urges the second positioning portions 921 to always remain engaging with the first positioning portions 905, the cord shaft 92 can be effectively limited and will not rotate again, so as that the bottom end of the first cord 5 is effectively fixed and remains the preset length.

In an embodiment as shown in FIGS. 10-12, the first positioning portions 905 are positioning holes defined in the end wall bounding the inner hole 901, and the second positioning portions 921 are positioning pins formed on an end wall of an insertion end of the cord shaft 92. Of course, it can be understood that the positions of the positioning holes and the positioning pins can be exchanged with each other. The elastic member 943 can be a coil spring.

The embodiments of the present invention have been described above with reference to the accompanying drawings, but the present invention is not limited to the specific implementations described above, and the specific implementations described above are only schematic and not limiting. Under the enlightenment of this invention, many forms can be made without departing from the scope of this invention and the scope of protection of the claims, and these are all included in the scope of protection of this invention.

What is claimed is:

1. A Roman shade, comprising:
a top beam;
a first cording winding and unwinding device mounted to the top beam;
a shade body suspended below the top beam and forming a plurality of positioning members in a height direction;
a middle beam fixed to a top end of the shade body;
a bottom beam fixed to a bottom end of the shade body;
a first cord comprising a top end fixed to the first cord winding and unwinding device, and a bottom end extending through the plurality of positioning members in turn, and then being fixed to the bottom beam;
a second cord winding and unwinding device mounted to the top beam; and
a second cord comprising a bottom end fixed to the middle beam, and a top end connected to the second cord winding and unwinding device;
wherein the first cord winding and unwinding device drives the bottom beam to rise or fall through winding or unwinding the first cord, so as to fold or unfold the shade body; and
wherein the second cord winding and unwinding device drives the middle beam to rise or fall through winding or unwinding the second cord, so as to unfold or fold the shade body.

2. The Roman shade of claim 1, wherein the middle beam defines a through hole, the first cord extends through the middle beam through the through hole.

3. The Roman shade of claim 2, wherein a fixing mechanism is assembled in the through hole, for fixing the second cord and for the first cord extending through, wherein the fixing mechanism comprises a mounting tube fixed in the through hole and axially defining a mounting hole, and a positioning ring tightly plugged in an end of the mounting hole and defining a core hole in a middle; wherein the first cord extends through the middle beam, through the mounting hole and the core hole, the bottom end of the second cord is clamped and positioned by an outer wall of the positioning ring and a wall bounding the mounting hole.

4. The Roman shade of claim 3, wherein the positioning ring is plugged in a bottom end of the mounting hole from bottom to top, and the positioning ring is a truncated cone or a prism, which is thin at a top and thick at a bottom; wherein the bottom end of the second cord is wound on the positioning ring, by extending through the core hole, a part of the second cord abutted against the outer wall of the positioning ring is clamped and positioned by the outer wall of the positioning ring and the wall bounding the mounting hole.

5. The Roman shade of claim 4, wherein the mounting tube comprises an inner tube axially defining a first shaft hole and forming a first limiting tab on an end, and an outer tube axially defining a second shaft hole and forming a second limiting tab on an end; wherein the inner tube and the outer tube are plugged in the through hole, from a top end and a bottom end of the through hole, respectively; the first limiting tab and the second limiting tab are abutted against a top surface and a bottom surface of the middle beam, respectively; the inner tube is also plugged in the outer tube, and an outer wall of the inner tube forms a plurality of protruded rings, for increasing friction between the outer wall of the inner tube and an inner wall of the outer tube; the first shaft hole and the second shaft hole are communicated with each other, to form the mounting hole.

6. The Roman shade of claim 5, wherein a bottom end of the second shaft hole is shaped into a truncated cone hole or a prism hole, which is thin at a top and thick at a bottom, for fitting with the positioning ring.

7. The Roman shade of claim 4, wherein an inner wall bounding the core hole defines a slot, and a part of the second cord located in the core hole is snapped in the slot.

8. The Roman shade of claim 1, wherein each of the first and second cord winding and unwinding device comprises a power mechanism mounted to the top beam, a transmission rod driven to rotate by the power mechanism, a reel fitted about the transmission rod and relatively fixed in a circumferential direction with the transmission rod, a screw nut fixed to the top beam and screwed to the reel, and a cord guide member mounted to the top beam for guiding the first cord or the second cord to be wound on the reel, wherein the top ends of the first cord and the second cord are wound on the reels of the first and second cord winding and unwinding devices, respectively.

9. The Roman shade of claim 8, wherein the power mechanism comprises a housing assembled to a middle of the transmission rod, a spring shaft and an output shaft rotatably mounted in the housing in parallel, and a scroll spring fitted about the spring shaft and fixed to the output shaft with an outer end; wherein each transmission rod is circumferentially fixed to the output shaft of one power mechanism and one of the first and second cord winding and unwinding devices, and coaxially extends through the spring shaft of the other power mechanism of the first and second cord winding and unwinding devices; wherein the first and second cord winding and unwinding devices each comprises two reels respectively assembled to two opposite ends of the transmission rod; wherein the first cord, the second cord, the screw nut, and the cord guide member are set one-to-one correspondence with the reels of the first and second cord winding and unwinding devices; two cord guide members located at same ends of the transmission rods of the first and second cord winding and unwinding devices are integrally formed.

10. The Roman shade of claim 1, further comprising a cord adjustment device mounted between the bottom end of the first cord and the middle beam, to adjust a length of the first cord, wherein the cord adjustment device comprises:
a sleeve fixed to the bottom beam, wherein an axis of the sleeve is perpendicular to the shade body, and the sleeve is open at one end and close at the other end; a wall of the sleeve defines a cord groove communicating with an inner hole of the sleeve and extending along an axial direction of the sleeve, an end wall of the closed end of the sleeve defines a plurality of first positioning portions evenly distributed around an axis of the sleeve;
a cord shaft extending into the sleeve through the open end and rotatably mounted to the sleeve, wherein the bottom end of the first cord extends through the cord groove and is wound on the cord shaft, an end of the cord shaft outside the sleeve forms a turning handle, for operating the cord shaft to rotate, an inner end surface of the cord shaft forms two second positioning portions, for cooperating with the plurality of first positioning portions to prevent the cord shaft from rotation; and
an adjustable locking assembly used to keep the second positioning portions of the cord shaft and the plurality of first positioning portions in a mated state, wherein the adjustable locking assembly comprises a screw extending through a locking hole defined in the cord shaft to be screwed in a screw hole defined in a middle of the end wall of the sleeve, and an elastic member arranged between a head of the screw and the cord shaft for being elastically abutted against the cord shaft to keep the second positioning portions and the plurality of first positioning portions in the mated state.
